(19) United States
(12) Patent Application Publication
(10) Pub. No.: US 2001/0024167 A1
(43) Pub. Date: Sep. 27, 2001

(54) Device for detecting the exceeding of a speed for a motor vechicle

(76) Inventor: Luis Henrique Da Silveira Loss, Porto Allegre (BR)

Correspondence Address: QUARLES & BRADY LLP, 411 E. WISCONSIN AVENUE, SUITE 2040, MILWAUKEE, WI, 53202-4497, US

(21) Appl. No.: 09/814,881

(22) Filed: Mar. 22, 2001

(30) Foreign Application Priority Data
Mar. 22, 2000 (FR) 00 03647

(51) Int. Cl. G08G 1/01

(52) U.S. Cl. 340/936; 340/425.5; 340/438

(57) ABSTRACT

The device includes comparator circuits (15, 16) to compare the value of the output signal of an odometer (7) with a reference value written to the memory (14) and circuits (13) for writing to the memory (14), which are arranged to write thereto the value of the output signal of the odometer (7).

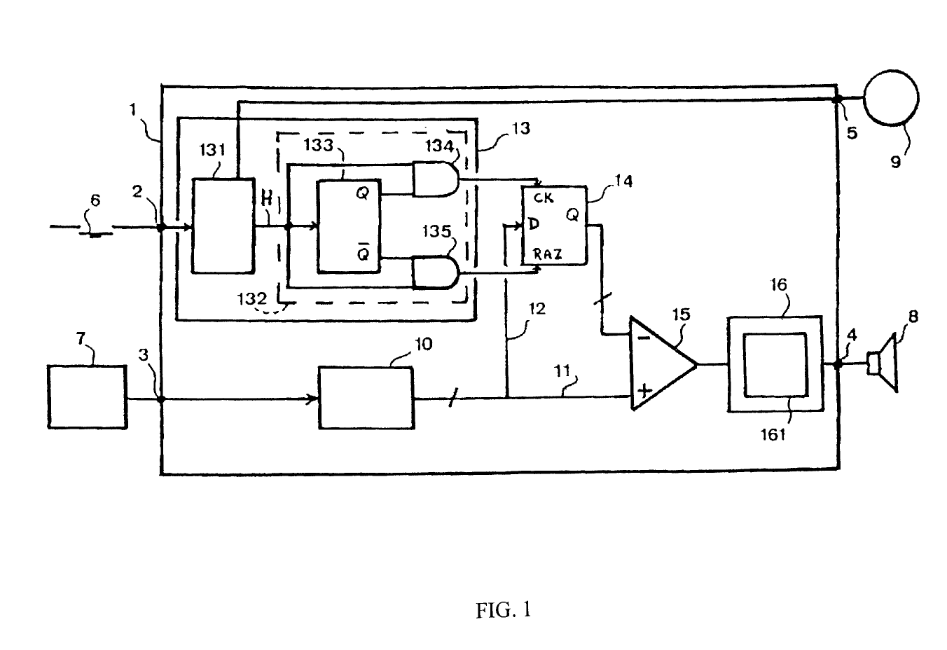

The present invention relates to on-board devices for detecting that a reference speed assigned to a motor vehicle has been exceeded.

The driver of a vehicle equipped with such a device can, for example select the maximum speed permitted for a road and the device warns him immediately if he is in contravention of the limit. The driver is thus freed from having to monitor the speedometer and this facilitates his driving.

A conventional device for detecting that a reference speed has been exceeded includes a comparator for controlling a buzzer or warning light connected on the one hand to an odometer measuring the vehicle speed and on the other to a memory containing the value of the reference speed. This speed can be selected by using a keypad or any other man-machine interface means.

However, the keypad means that it is necessary to reserve space on the dashboard which is already cluttered. Furthermore, in vehicles where the dashboard has not been designed to receive the keypad it is impossible to install such a device.

The present invention aims to overcome this restriction of availability of space.

To this end the invention relates to a device for detecting the exceeding of a speed for a motor vehicle with means for comparison, for controlling a warning device, for comparing the value of the output signal of an odometer with a reference value written to the memory and means for writing to the memory, characterised in that the write means are arranged to write the odometer output signal value to the memory under the control of an actuating member.

The write means are preferably arranged alternately to command storage of a reference speed and to command its deletion upon successive actuations of the actuating member.

The invention will be better understood with the aid of the following description of a preferred embodiment of the detection device according to the invention with reference to the single attached figure which is a schematic illustration.

The device illustrated and bearing the reference 1 in the figure is mounted on a motor vehicle to detect speed in excess of a reference speed.

It includes a comparator 15 connected at the input on the one hand by a connection 11, in this case a parallel bus, to an odometer 7 and on the other to the outputs Q of a memory 14, in this case a parallel/parallel flip-flop register D, to which the reference value has been written. Write circuits 13, which the driver of the vehicle can activate, control a clock signal input CK of the memory 14, commanding the storage of a reference speed value presented to the inputs D.

Since the odometer 7 supplies pulses at a frequency proportional to the speed of the vehicle there are provided—between the input 3 connected to the odometer 7 and the connection 11—converter circuits 10 having a frequency meter function. The converter circuits 10 cyclically provide, on the parallel connection 11, a byte of a value representing the momentary frequency and thus the speed of the vehicle. The connection 11 includes a branch 12 terminating at the value inputs D of the memory 14.

The write circuits 13 are controlled by man-machine interface circuits and specifically in this case by a manually operated switch 6 allowing passage of an activation voltage of the write circuits 13 when it is in its active state. In the specific case of this example, the switch 6 is an automatic-return push button which also operates a windscreen washer motor 9.

In order to distinguish between the two types of operation of the button 6—storage of the reference speed and activation of the motor 9—the write circuits 13 include a circuit 131 for determining, or distinguishing, the duration of activation of the button 6. If the operating voltage from the button 6 represents a pulse of duration less than a predetermined threshold, stored in the circuit 131, this latter activates, by a short pulse H, the clock input of the memory 14, thus commanding storage of the momentary speed value from the converter 10. If, on the other hand, the operating voltage provided by the button 6 reaches or exceeds this threshold, in this case 0.5 s, the circuit 131 only applies an activation voltage to a terminal 5 connected to the motor 9. The power amplifier circuits required for operating the motor 9 are not shown.

The write circuits 13 also include, in this example, a switching circuit 132, or demultiplexer, mounted in series between the output of the circuit 131 and the clock input CK of the memory 14. The switching circuit 132 includes a counter 133 with one stage, dividing by 2, controlled by the short pulses H from the circuit 131 and of which the complementary outputs Q and Q,- control, in phase opposition, two AND gates 134 and 135 respectively for switching pulses H respectively to the clock input CK of the memory 14 and to a resetting input (RAZ) thereof.

The comparator 15 changes state when the momentary speed value on the connection 11 exceeds the reference speed from the memory 14. In this case the reference value is applied to the negative input of the comparator 15 and this therefore signals any comparison result (difference calculation) having a positive sign.

The output of the comparator 15 controls signal-adapting circuits connected to an output terminal 4 for connection to a warning device, in this case a buzzer 8. In one variation, the buzzer or a warning display device is integrated into the device 1.

In this example the comparator 15 is formed by a subtracter which, apart from the sign of the difference between the input signals, also supplies the value of this difference, ie. the value representing the excess speed. The circuits 16 include a stored table 161 showing correspondence between the value of the excess speed which they receive and the command to be applied to the terminal 4. In this way a set of a plurality of successive sections of increasing excess speed values is defined with which a set of respective commands for the buzzer 8 is associated. These commands correspond in this case to a set of increasing frequencies of activation pulses for the buzzer 8.

The operation of the detection device illustrated will now be explained in more detail.

The driver of the vehicle equipped with the detection device 1 chooses, in an initial phase, a reference speed, for example 90 km/hr. In order to do this he drives his vehicle at this reference speed and activates the button 6 for a short time, less than the threshold of 0.5 s. The distinguishing circuit 131 thus detects the end of the activation of the button 6 less than 0.5 s after the beginning of this activation and thus controls the clock input CK of the memory 14 which stores the momentary value (90 km/hr) provided by the odometer 7. The counter 133, which is set (Q=1) upon powering up by a circuit (not shown), has thus switched the pulse H via the gate 134 to the clock input CK of the memory 14. The counter 133 changes state on the trailing, falling edge of the pulses H, ie. it falls back to the 0 state after this first pulse H and thus releases the input, which it controls, of the resetting gate 135; however, its output remains in the 0 state by reason of the 0 state which the pulse signal H has just assumed. The write circuits 13, which write to the memory 14 the value of the output signal of the odometer 7, actually control, by the clock signal H, writing access gates (inputs D) to the memory points from the connection 12. These gates of the inputs D thus constitute write switches connecting the bus 11, 12 to the memory 14 on command of the driver.

The device thus requires no keypad for selecting the reference speed nor even, in this example any specific key for storing this speed. It can therefore be located outside the dashboard.

Then, in the operational phase, the comparator 15 supplies the sequence of values representing the momentary excess speed and the momentary value addresses the table 161 of the circuits 16 to select the corresponding operating frequency of the buzzer 8. If the speed is not exceeded, the momentary value output from the comparator 15 is invalidated by the negative sign associated therewith.

In the event of a second activation of the button 6 for a period less than the threshold, the circuit 131 provides a second pulse B which on this occasion is switched to the resetting input RAZ of the memory 14 by the gate 135 which has been released right at the end of the preceding cycle linked to the first activation of the button 6.

A third activation of the button 6 under the conditions mentioned above makes it possible to store another reference speed value.

The circuits 13 commanding storage of the reference speed value are thus designed alternately to command storage of such a value and to command its deletion upon successive activation of the switch 6.

If, on the other hand, the button 6 is activated for at least the threshold duration of 0.5 s, the circuit 131 activates its output connected to the terminal 5 for connection to the motor 9, and provides no pulse H. The operation of the motor 9 by the button 6 is simply delayed, or cut, by the threshold value of 0.5 s. The circuit 131 can be designed to extend the end of the signal applied to the terminal 5 accordingly so that the driver does not have to activate the button 6 for an increased time when he wishes to operate the motor 9.

1. Device for detecting the exceeding of a speed for a motor vehicle with means (15, 16) for comparison, for controlling a warning device (8), for comparing the value of the output signal of an odometer (7) with a reference value written to the memory (14) and means (13) for writing to the memory (14), characterised in that the write means (13) are arranged to write the value of the output signal of the odometer (7) to the memory (14) under the control of an actuating member (6).

2. Device according to claim 1, wherein the write means (13) are arranged alternately to command storage of a reference speed and to command its deletion upon successive actuations of the actuating member (6).

3. Device according to claim 2, wherein the write means (13) include a switching circuit (132) connected to a clock input (CK) and a resetting input (RAZ) of the memory (14) also connected to the odometer (7) by writing access gates (D).

4. Device according to claim 1, wherein the actuating member is a switch (6) for operating a vehicle member (9) and the write means (13) include means (131) for determining a duration of activation of the switch (6), which are arranged to control the memory (14) if the duration of activation is less than a threshold and, if this is not the case, to operate the member (9) of the vehicle.

5. Device according to claim 1, wherein the comparator means (15, 16) are arranged to supply a value by which the reference speed is exceeded and to operate warning means (8) according to the said value.
